(19) United States
(12) Patent Application Publication
(10) Pub. No.: US 2022/0046958 A1
(43) Pub. Date: Feb. 17, 2022

(54) FORTIFIED BEVERAGE COMPOSITION AND PROCESS OF PREPARING THEREOF

(71) Applicant: ABT HEALTH AND WELLNESS PRIVATE LIMITED, Coimbatore (IN)

(72) Inventor: M.HARIHARA SUDHAN, COIMBATORE (IN)

(73) Assignee: ABT HEALTH AND WELLNESS PRIVATE LIMITED

(21) Appl. No.: 17/060,153

(22) Filed: Oct. 1, 2020

(30) Foreign Application Priority Data
Aug. 14, 2020 (IN) 202041035066

(51) Int. Cl. A23L 2/06; A23L 2/60; A23L 2/56; A23L 33/15; A23L 33/175; A23L 29/262

(52) U.S. Cl. CPC A23L 2/06; A23L 2/60; A23L 29/262; A23L 33/15; A23L 33/175; A23L 2/56

(57) ABSTRACT

A fortified beverage composition and process of preparing thereof is disclosed. a plurality of the micronutrient nanoparticles encapsulated within one or more phospholipid layers, wherein the micronutrient nanoparticles being selected from a group consisting vitamin C, lysine, and proline, wherein the micronutrient nanoparticles comprise 0.5% wt of vitamin C, 0.25% wt of lysine, 0.05% wt of proline and a fruit juice comprising at least one of mango pulp, sugar, stevia, citric acid, flavoring agent, and water. 7.A process for preparing a fortified beverage composition comprises mixing and homogenizing the phospholipid blended water and the plurality of micronutrient dissolved water to form micronutrient encapsulated phospholipid layers, adding of citric acid to the homogenized solution and the mixed solution is passed through a sonicator. Next blending of the sonicated solution along with a fruit juice and passing of final product through homogenizer, ultra-heat treatment and to a filling machine for packing.

### CROSS-REFERENCE TO RELATED APPLICATION

This application claims priority from a Patent Application filed in India bearing application no. 202041035066, filed on Aug. 14, 2020 and titled “A FORTIFIED BEVERAGE COMPOSITION AND PROCESS OF PREPARING THEREOF”.

### FIELD OF INVENTION

Embodiments of the present invention relates to a micronutrients fortified beverage composition and more particularly it relates to a beverage composition comprising a plurality of micronutrients such as vitamin C, lysine and proline and process of preparing thereof.

### BACKGROUND

Mitochondria are rod-shaped organelles that can be considered the power generators of the cell, converting oxygen and nutrients into adenosine triphosphate (ATP). ATP is the chemical energy “currency” of the cell that powers the cell's metabolic activities. All diseases which afflict the human being can be attributed to the malfunctioning of the mitochondria and the damage occurred to the mitochondria can be reversed. Nutrients such as vitamin C, lysine and proline plays vital role in enhancing mitochondrial health. Thus, safe delivery of these nutrients to the mitochondria is required.

Lysine and proline amino acids are the precursors of hydroxylysine and hydroxyproline, wherein these two are constituents of collagen. Collagen is an essential component of arterial linings. Also, the vitamin C is also a strong antioxidant and is essential for production of collagen.

While vitamin C is abundantly available in many fresh fruits and vegetables, the essential amino acids lysine and proline is not readily available in all the fruits and vegetables. Presently available products for lysine and proline supplements in the market are predominantly either in the form of capsules or in powder form which may not be preferred by all.

Hence, there is need for a simple beverage fortified with vitamin C, lysine and proline and method of preparation thereof for delivery of these nutrients.

### SUMMARY

In accordance with an embodiment of the present invention, a fortified beverage composition comprises of a plurality of the micronutrient nanoparticles encapsulated within one or more phospholipid layers, wherein the micronutrient nanoparticles being selected from a group consisting of vitamin C, lysine, and proline, wherein the micronutrient nanoparticles comprise 0.5% wt of vitamin C, 0.25% wt of lysine, 0.05% wt of proline; and a fruit juice comprising at least one of mango pulp, sugar, stevia, citric acid, flavoring agent, and water.

In accordance with an embodiment of the present invention, the fruit juice comprises of 21.5% wt of mango pulp, 9% wt of sugar, 0.01% wt of citric acid, 0.05% wt of flavouring agent, and 67.14% wt of water.

In accordance with another embodiment of the present invention, the fruit juice comprises of 50% wt of mango pulp, 0.02% wt of stevia, 0.01% wt of citric acid, 0.05% wt of flavouring agent, and 47.62% wt of water.

In accordance with an embodiment of the present invention, the one of phospholipid layers comprises phospholipids derived from soy lecithin.

In accordance with an embodiment of the present invention, the phospholipids comprise 1.5% wt.

In accordance with an embodiment of the present invention, wherein the micronutrients nanoparticles are in the range of 300 nanometers and below.

In accordance with an embodiment of the present invention, wherein the value of pH of the micronutrient fortified beverage is in the range of 3.70 to 3.90.

In accordance with an embodiment of the present invention, wherein the stabilizer comprises of carboxyl methyl cellulose.

In accordance with an embodiment of the present invention, wherein the flavoring agent comprises of natural mango flavor.

In accordance with an embodiment of the present invention, a process for preparing a fortified beverage composition comprises of washing phospholipids with alcohol and blending the washed phospholipids with water, dissolving a plurality of micronutrients nanoparticles in the water, wherein the plurality of micronutrients nanoparticles comprises 0.5% wt of vitamin C, 0.25% wt of lysine, and 0.05% wt of proline; mixing and homogenizing the phospholipid blended water and the plurality of micronutrient dissolved water to obtain a one or more micronutrient encapsulated phospholipid layers; adding of citric acid to the homogenized solution and the mixed solution is passed through a sonicator; blending of the sonicated solution along with a fruit juice comprising at least one of mango pulp, sugar, citric acid, flavoring agent, and water; passing of final product through homogenizer and subjecting the homogenized final product for ultra-heat treatment before passed to a filling machine for packing.

In accordance with an embodiment of the present invention, the fruit juice comprises of 21.5% wt of mango pulp, 9% wt of sugar, 0.01% wt of citric acid, 0.05% wt of flavouring agent, and 67.14% wt of water.

In accordance with an embodiment of the present invention, the fruit juice comprises 50% wt of mango pulp, 0.02% wt of stevia, 0.01% wt of citric acid, 0.05% wt of flavouring agent, and 47.62% wt of water.

In accordance with an embodiment of the present invention, the one of phospholipid layers comprises phospholipids derived from soy lecithin and wherein the phospholipids comprise 1.5% wt.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a table illustrating composition of a fortified beverage, in accordance with an embodiment of the present invention.

FIG. 2 is a table illustrating composition of a fortified sugar-free beverage, in accordance with an embodiment of the present invention.

FIG. 3 is a flow diagram representing steps involved in a process for preparing the fortified beverage composition, in accordance with an embodiment of the present invention.

FIG. 4 is a table illustrating various parameters of normal fortified beverage composition, in accordance with an embodiment of the present invention.

FIG. 5 is a table illustrating various parameters of sugar-free fortified beverage composition, in accordance with an embodiment of the present invention.

FIG. 6 is a table illustrating analysis of natural mango flavor, in accordance with an embodiment of the present invention.

FIG. 7 is a table illustrating quality control analysis of the stabilizer, in accordance with an embodiment of the present invention.

Further, those skilled in the art will appreciate that elements in the figures are illustrated for simplicity and may not have necessarily been drawn to scale. Furthermore, in terms of the method steps, chemical compounds, and parameters used herein may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

It is an objective of the present invention to provide a non-alcoholic fortified beverage composition which is easy to use and scale up with a good shelf-life at room temperature and provide micronutrients vitamin C, lysine and proline in the fruit juice.

Embodiments of the present invention discloses a fortified beverage composition comprises of a plurality of the micronutrient nanoparticles encapsulated within one or more phospholipid layers, wherein the micronutrient nanoparticles being selected from a group consisting vitamin C, lysine, and proline, wherein the micronutrient nanoparticles comprise 0.5% wt of vitamin C, 0.25% wt of lysine, 0.05% wt of proline and a fruit juice comprising at least one of mango pulp, sugar, stevia, citric acid, flavoring agent, and water.

As described herein the term “fortified” refers to a process of food fortification or enrichment of adding micronutrients to food. Also as used herein the term “beverage” refers to a non-alcoholic fruit juice intended for human consumption. Also, it may be noted that that all the ingredients disclosed herein below may be readily obtained from the market.

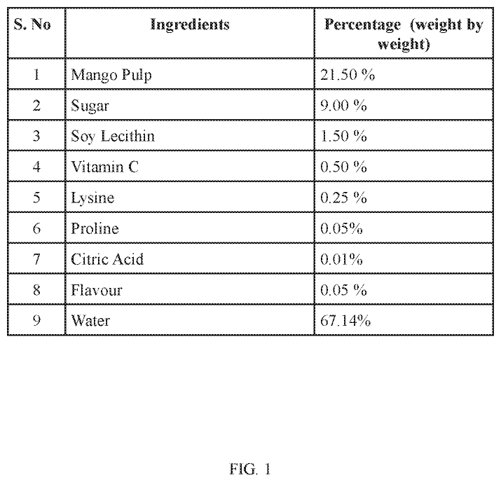

FIG. 1 is a table illustrating composition of a fortified beverage, in accordance with an embodiment of the present invention. The fortified beverage composition comprises of plurality of the micronutrient nanoparticles encapsulated within one or more phospholipid layers wherein the micronutrient nanoparticles being selected from a group consisting vitamin C, lysine, and proline, wherein the micronutrient nanoparticles comprise 0.5% wt of vitamin C, 0.25% wt of lysine, 0.05% wt of proline; and a fruit juice comprising at least one of mango pulp, sugar, stevia, citric acid, flavoring agent, and water.

According to an embodiment of the present invention, the fruit juice comprises of 21.5% wt of mango pulp, 9% wt of sugar, 0.01% wt of citric acid, 0.05% wt of flavouring agent, and 67.14% wt of water.

According to an embodiment of the present invention, the one of phospholipid layers comprises of phospholipids derived from soy lecithin, wherein the phospholipids comprises of 1.5% wt.

According to an embodiment of the present invention, the micronutrient nanoparticles are in the range of 300 nanometers and below.

According to an embodiment of the present invention, the value of pH of the micronutrient fortified beverage is in the range of 3.70 to 3.90. Further the stabilizer comprises of carboxyl methyl cellulose and the flavoring agent comprises of natural mango flavor.

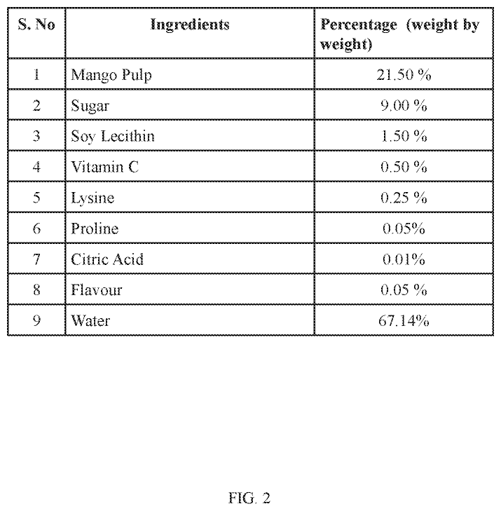

FIG. 2 is a table illustrating composition of a fortified sugar-free beverage, in accordance with an embodiment of the present invention. The fortified sugar-free beverage composition comprises of plurality of the micronutrient nanoparticles encapsulated within one or more phospholipid layers wherein the micronutrient nanoparticles being selected from a group consisting vitamin C, lysine, and proline, wherein the micronutrient nanoparticles comprise 0.5% wt of vitamin C, 0.25% wt of lysine, 0.05% wt of proline; and a fruit juice comprising at least one of mango pulp, sugar, stevia, citric acid, flavoring agent, and water.

According to an embodiment of the present invention, the sugar-less fruit juice comprises of 50% wt of mango pulp, 0.02% wt of stevia, 0.01% wt of citric acid, 0.05% wt of flavouring agent, and 47.62% wt of water.

According to an embodiment of the present invention, the one of phospholipid layers comprises of phospholipids derived from soy lecithin, wherein the phospholipids comprises of 1.5% wt.

According to an embodiment of the present invention, the micronutrient nanoparticles are in the range of 300 nanometers and below.

According to an embodiment of the present invention, the value of pH of the micronutrient fortified beverage is in the range of 3.70 to 3.90. Further the stabilizer comprises of carboxyl methyl cellulose and the flavoring agent comprises of natural mango flavor.

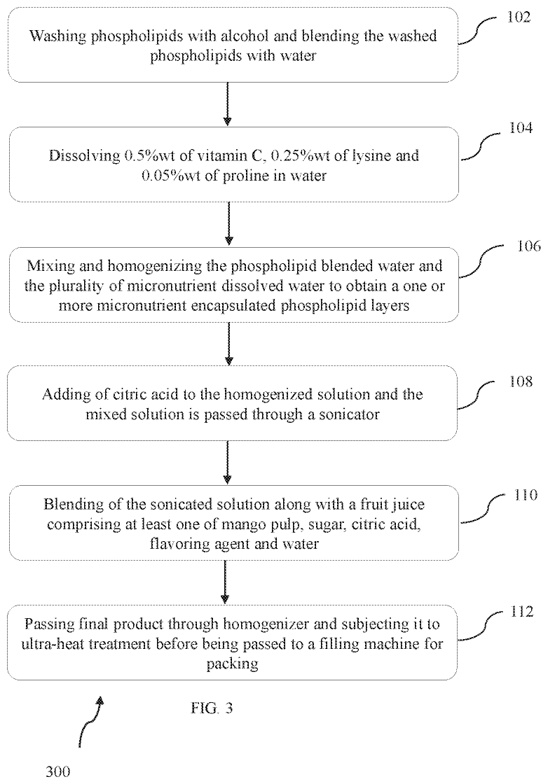

FIG. 3 is a flow diagram representing steps involved in a process for preparing the fortified beverage composition, in accordance with an embodiment of the present invention. The process comprises of washing phospholipids with alcohol and blending the washed phospholipids with water at step 102.

Next at step 104, it involves dissolving a plurality of micronutrients in the water wherein the plurality of micronutrients nanoparticles comprises of 0.5% wt of vitamin C, 0.25% wt of lysine and 0.05% wt of proline.

Next at step 106, mixing and homogenizing the phospholipid blended water and the plurality of micronutrient dissolved water to obtain a one or more micronutrient encapsulated phospholipid layers. Followed by at step 108, adding of citric acid to the homogenized solution and the mixed solution is passed through a sonicator. Using the high powered sonicator achieves the desired particle size and the properties i.e., achieve micronutrients nanoparticles in the range of 300 nanometers and below.

At step 110, blending of the sonicated solution along with a fruit juice comprising at least one of mango pulp, sugar, citric acid, flavoring agent and water. Finally, at step 112, the final product is passed through homogenizer and subjected to ultra-heat treatment before being passed to a filling machine for packing. In an embodiment, the obtained fortified beverage composition may be packed in at least one of plastic pouches, bottles and tetra packs.

According to an embodiment of the present invention, the fruit juice comprises of 21.5% wt of mango pulp, 9% wt of sugar, 0.01% wt of citric acid, 0.05% wt of flavouring agent, and 67.14% wt of water.

According to another embodiment of the present invention, the sugar-less fruit juice comprises of 50% wt of mango pulp, 0.02% wt of stevia, 0.01% wt of citric acid, 0.05% wt of flavouring agent, and 47.62% wt of water.

According to an embodiment of the present invention, the phospholipid layers comprises of phospholipids derived from soy lecithin and wherein the phospholipids comprise 1.5% wt.

According to an embodiment of the present invention, the value of pH of the micronutrient fortified beverage is in the range of 3.70 to 3.90. Further the stabilizer comprises of carboxyl methyl cellulose and the flavoring agent comprises of natural mango flavor.

It may be appreciated by the person skilled in the art that all the liposomal products in the market are based with alcohol whereas the fortified beverage composition as herein above is a water-based liquid prepared using the process disclosed hereinabove. Further the fortified beverage composition disclosed in the present invention is prepared by processing the phospholipids to remove fats.

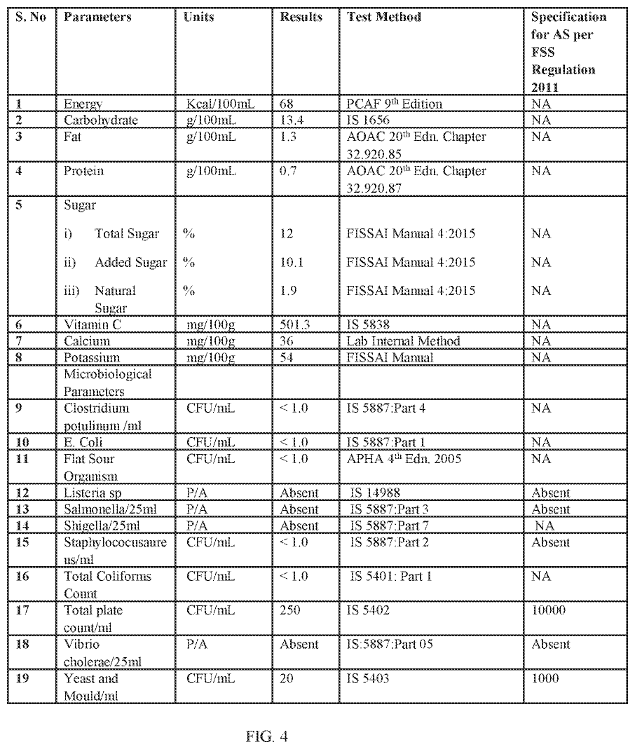

FIG. 4 is a table illustrating various parameters of normal fortified beverage composition, in accordance with an embodiment of the present invention. According to an embodiment, a parameter analysis for energy, carbohydrate, fat, protein, sugar, vitamin-c, calcium and potassium was carried for the normal fortified beverage composition. Further microbiological parameter analysis was also carried for analysis stability and microbial growth as shown in FIG. 4. Based on the analysis, it was found that the parameters illustrated in the FIG. 4 meets the requirements for FSSAI Standards and that the fortified beverage composition is fit for consumption up to 11 months from the date of manufacturing.

According to an embodiment of the present invention, no additional refrigeration is necessary for the storage of the fortified beverage composition prepared by the process 300 disclosed in the present invention and the storage stable fortified beverage composition may be stored at cool and dry place at room temperature for about 11 to 12 months.

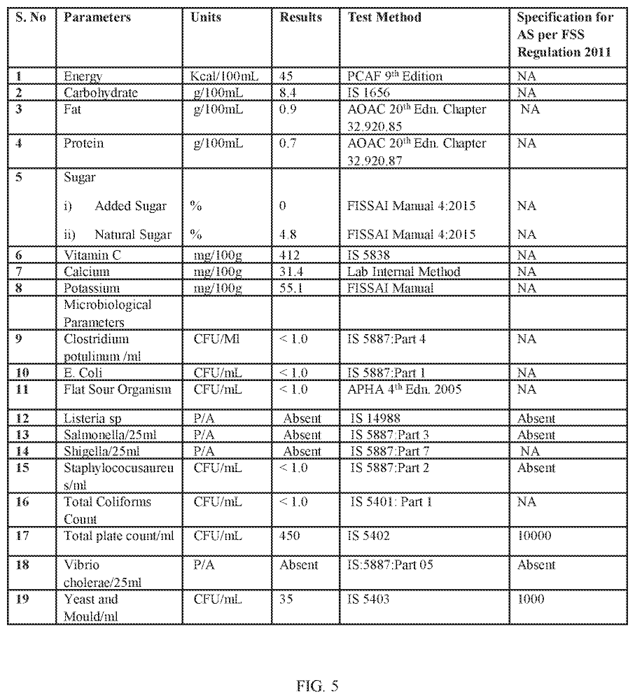

FIG. 5 is a table illustrating various parameters of sugar-free fortified beverage composition, in accordance with an embodiment of the present invention. According to an embodiment, a parameter analysis for energy, carbohydrate, fat, protein, sugar, vitamin-c, calcium and potassium was carried for the normal fortified beverage composition. Further microbiological parameter analysis was also carried for analysis stability and microbial growth as shown in FIG. 4. Based on the analysis, it was found that the parameters illustrated in the FIG. 4 meets the requirements for FSSAI Standards and that the fortified beverage composition is fit for consumption up to 10 months from the date of manufacturing.

According to an embodiment of the present invention, no additional refrigeration is necessary for the storage of the sugar-free fortified beverage composition prepared by the process 300 disclosed in the present invention and the storage stable fortified beverage composition may be stored at cool and dry place at room temperature for about 10 to 11 months.

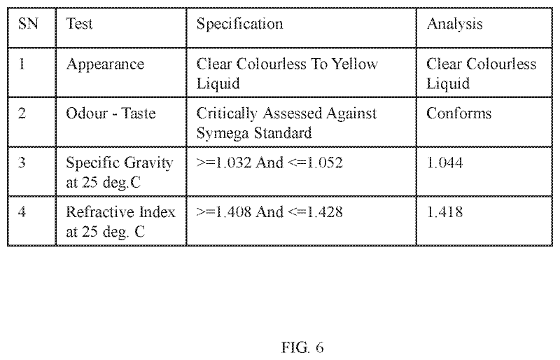

FIG. 6 is a table illustrating analysis of natural mango flavor, in accordance with an embodiment of the present invention. The analysis has been carried out for the following parameters such as appearance, odour-taste, Specific Gravity at 25 deg. C and Refractive Index at 25 deg. C.

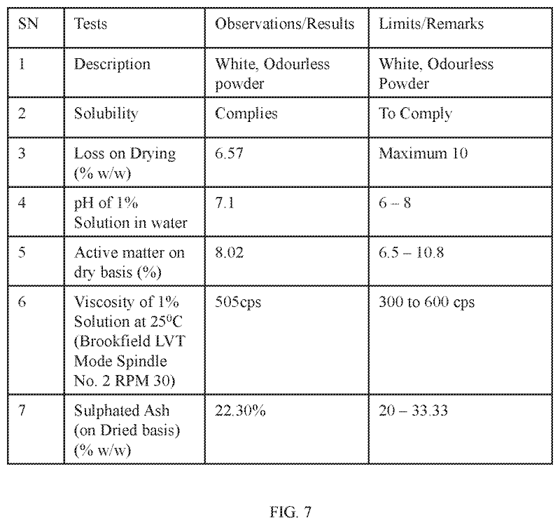

FIG. 7 is a table illustrating quality control analysis of the stabilizer, in accordance with an embodiment of the present invention. The stabilizer used in the fortified beverage composition comprises of Carboxyl Methyl Cellulose (CMC), and the analysis of the stabilizer is illustrated in FIG. 7, wherein the various tests such as description, solubility, loss on drying (% w/w), pH of 1% solution in water, active matter on dry basis (%), viscosity of 1% Solution at 250 C (Brookfield LVT Mode Spindle No. 2 RPM 30) and Sulphated Ash (on Dried basis) (% w/w).

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A fortified beverage composition, comprising:
a plurality of the micronutrient nanoparticles encapsulated within one or more phospholipid layers,
wherein the micronutrient nanoparticles being selected from a group consisting vitamin C, lysine, and proline,
wherein the micronutrient nanoparticles comprise
0.5% wt of vitamin C,
0.25% wt of lysine,
0.05% wt of proline; and
a fruit juice comprising at least one of mango pulp, sugar, stevia, citric acid, flavoring agent, stabilizer and water.

2. The composition as acclaimed in claim 1, wherein the fruit juice comprises
21.5% wt of mango pulp,
9% wt of sugar,
0.01% wt of citric acid,
0.05% wt of flavouring agent, and
67.14% wt of water.

3. The composition as acclaimed in claim 1, wherein the fruit juice comprises
50% wt of mango pulp,
0.02% wt of stevia,
0.01% wt of citric acid,
0.05% wt of flavouring agent, and
47.62% wt of water.

4. The composition as claimed in claim 1, wherein the one of phospholipid layers comprises phospholipids derived from soy lecithin.

5. The composition as claimed in claim 1, wherein the phospholipids comprise 1.5% wt.

6. The composition as claimed in claim 1, wherein the micronutrients nanoparticles are in the range of 300 nanometers and below.

7. The composition as claimed in claim 1, wherein the value of pH of the micronutrient fortified beverage is in the range of 3.70 to 3.90.

8. The composition as claimed in claim 1, wherein the stabilizer comprises of carboxyl methyl cellulose.

9. The composition as claimed in claim 1, wherein the flavoring agent comprises of natural mango flavor.

10. A process for preparing a fortified beverage composition comprising:
washing phospholipids with alcohol and blending the washed phospholipids with water;
dissolving a plurality of micronutrients nanoparticles in the water, wherein the plurality of micronutrients nanoparticles comprises
0.5% wt of vitamin C,
0.25% wt of lysine, and
0.05% wt of proline;
mixing and homogenizing the phospholipid blended water and the plurality of micronutrient dissolved water to obtain a one or more micronutrient encapsulated phospholipid layers;
adding of citric acid to the homogenized solution and the mixed solution is passed through a sonicator;
blending of the sonicated solution along with a fruit juice comprising at least one of mango pulp, sugar, citric acid, flavoring agent, and water,
passing of final product through homogenizer and subjecting the homogenized final product for ultra-heat treatment before passed to a filling machine for packing.

11. The process as claimed in claim 10, wherein the fruit juice comprises
21.5% wt of mango pulp,
9% wt of sugar,
0.01% wt of citric acid,
0.05% wt of flavouring agent, and
67.14% wt of water,
wherein the flavoring agent comprises of natural mango flavour.

12. The process as claimed in claim 10, wherein the fruit juice comprises
50% wt of mango pulp,
0.02% wt of stevia,
0.01% wt of citric acid,
0.05% wt of flavouring agent, and
47.62% wt of water,
wherein the flavoring agent comprises of natural mango flavour.

13. The process as claimed in claim 10, wherein the one of phospholipid layers comprises phospholipids derived from soy lecithin and wherein the phospholipids comprise 1.5% wt.

14. The process as claimed in claim 10, wherein the value of pH of the micronutrient fortified beverage is maintained in the range of 3.70 to 3.90.
